(19) United States
(12) Patent Application Publication
(10) Pub. No.: US 2011/0145369 A1
(43) Pub. Date: Jun. 16, 2011

(54) DATA DOWNLOADING SYSTEM, DEVICE, AND METHOD

(75) Inventors: KUANG-YU CHEN, Tu-Cheng (TW); CHEN-HUANG FAN, Tu-Cheng (TW)

(73) Assignee: HON HAI PRECISION INDUSTRY CO., LTD., Tu-Cheng (TW)

(21) Appl. No.: 12/871,930

(22) Filed: Aug. 31, 2010

(30) Foreign Application Priority Data
Dec. 15, 2009 (CN) 200910311463.9

(51) Int. Cl. G06F 15/16

(52) U.S. Cl. 709/219; 709/246

(57) ABSTRACT

A downloading device is provided. The downloading device is connected to a server and a portable device. The portable device is for obtaining a picture of an object that includes an address data of required data stored in the server. The downloading device includes a communication module, an address recognizing module, and a downloading module. The communication module is for receiving the obtained picture transmitted from the portable device. The address recognizing module is for recognizing the address data from the received picture and changing the recognized address data to a character string. The downloading module is for downloading the required data from the server according to the address data through the communication module and transmitting the required data to the portable device through the communication module.

### BACKGROUND

1. Technical Field

The present disclosure relates to a data downloading system, device, and method.

2. Description of Related Art

With the development of information technology, most data is uploaded to servers for storing. When data is required, the user can download the required data from the server according to the address of the required data stored in the server. However, before the required data is downloaded from the server, the user must input the address of the required data manually. If a portable device, such as a cell-phone, is used to download the required data, due to the small size of the keyboard of the portable device, it's difficult and time consuming for user to input a long address.

### BRIEF DESCRIPTION OF THE DRAWINGS

The components of the drawings are not necessarily drawn to scale, the emphasis instead being placed upon clearly illustrating the principles of the data downloading system. Moreover, in the drawings, like reference numerals designate corresponding parts throughout several views.

FIG. 1 is a hardware architecture diagram of a data downloading system in accordance with a first embodiment.

FIG. 2 is block diagrams of a portable device and a downloading device of FIG. 1.

FIG. 3 is a schematic diagram of a picture, which includes the address data of the required data stored in a server.

FIG. 4 is a hardware architecture diagram of the system in accordance with a second embodiment.

FIG. 5 is a block diagram of a portable device of FIG. 4.

FIG. 6 is a flowchart of a data downloading method applied to the system of FIG. 1.

FIG. 7 is a flowchart of a data downloading method applied to the system of FIG. 4.

### DETAILED DESCRIPTION

A data downloading system (herein after “the system”) is provided. The system can recognize address data of required data, which is stored in a server from a picture, and download the required data according to the recognized data address. The picture is obtained by a portable device, such as a cell-phone. When the address data of the required data is displayed in another device (this device cannot download the required data directly), the portable device is used to obtain a picture from the device on which the address of the required data is displayed. For instance, when an e-book is used to read the address of a media file, which is included in a read page. The user cannot download the media file with the e-book. A cell-phone is used to obtain a picture of the read page and the system recognizes the address data of the media file from the picture of the read page and then downloads the media file according to the recognized data address. Two embodiments of the system will be described in detail below.

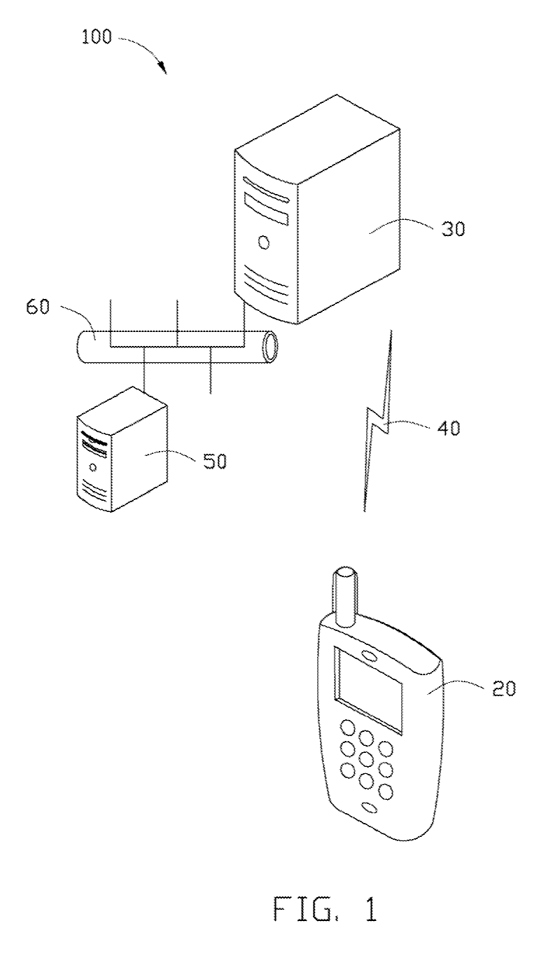

FIG. 1 is a hardware architecture diagram of the system 100 in accordance with a first embodiment. The system 100 includes a portable device 20, a downloading device 30, a server 50, a first connection 40, and a second connection 60. The potable device 20 is connected to the downloading device 30 through the first connection 40. The downloading device 30 is connected to the server 50 through the second connection 60. The first connection 40 is a wireless connection such as a BLUETOOTH connection or a WIFI connection. The second connection 60 is a wire connection, such as an Internet connection or an intranet connection. The portable device 20 can be a cell-phone. The downloading device 30 can be a computer.

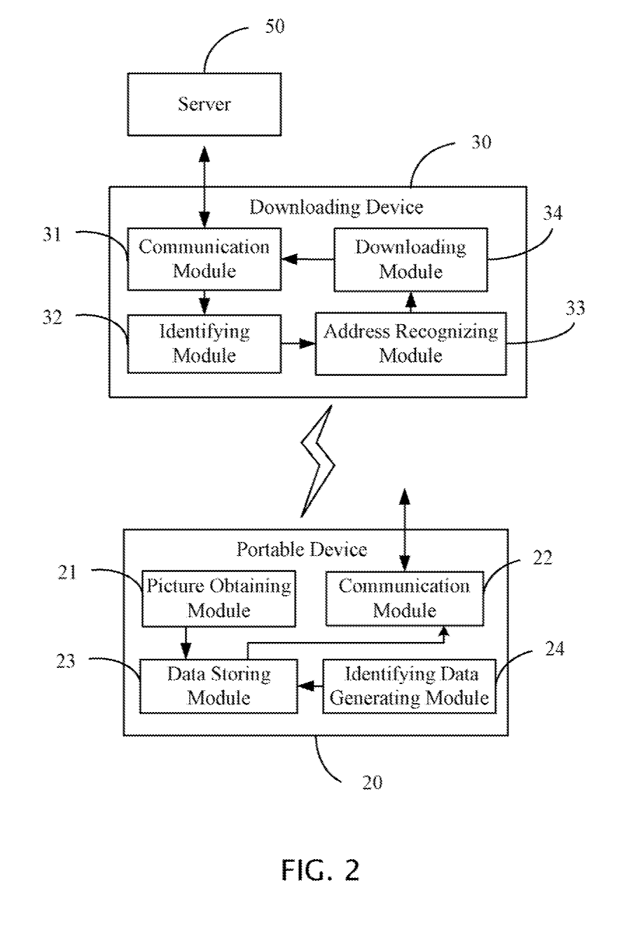

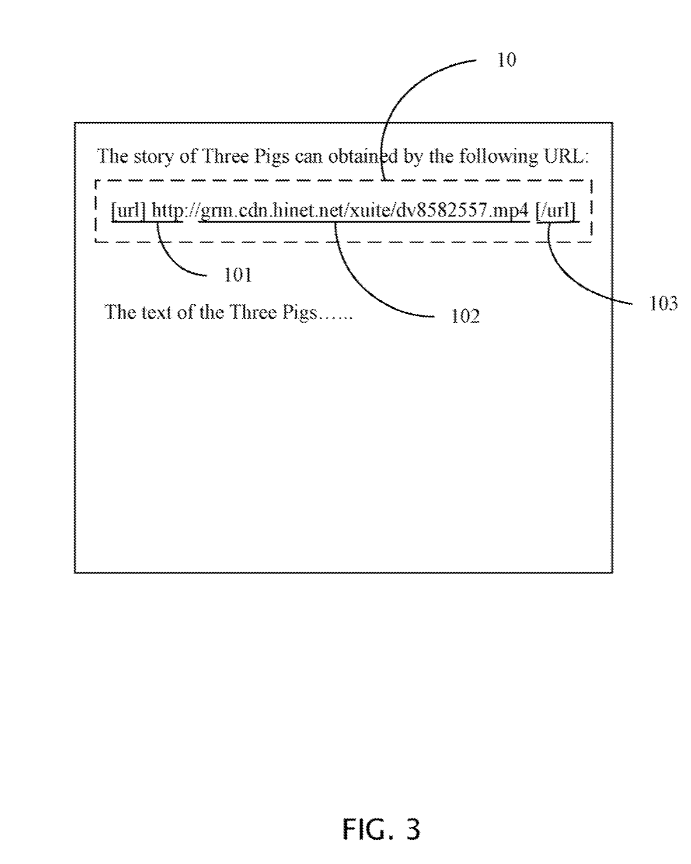

FIG. 2 is block diagrams of the portable device 20 and the downloading device 30 of FIG. 1. The portable device 20 includes a picture obtaining module 21, a communication module 22, a data storing module 23, and an identifying data generating module 24. The picture obtaining module 21 is for obtaining a picture which includes an address data 10 (see in FIG. 3) of the required data stored in the server 50. A schematic diagram of the picture is shown in FIG. 3. The format of the address data 10 can be: [url] http://grm.cdn.hinet.net/xuite/dv8582557.mp4 [/url], for example, wherein, the “[url]” or “http://” is an scheme name 101, the characters “grm.cdn.hinet.net/xuite/dv8582557.mp4” are an actual address 102, the [/url] is an address end indication 103 for indicating the address data has ended. The format of the address data 10 can be different in other embodiments.

The identifying data generating module 24 is for generating identification (ID) data for the portable device 20. If the portable device 20 is a cell-phone, the identification data of the portable device 20 can be International Mobile Equipment Identity (IMEI) of the cell-phone. The identification data also can be biometric data, such as fingerprint, of the user of the portable device 20. If the identification data is biometric data, the portable device 20 further includes biometric data collecting device (not shown) for collecting the biometric data of the user.

The data storing module 23 stores the obtained picture, the identification data, and the required data. The required data is downloaded from the server 50 with the downloading device 30 and is transmitted from the downloading device 30. The detailed description about downloading the required data is described below.

The communication module 22 sends the identification data and the obtained picture to the downloading device 30.

The downloading device 30 includes a communication module 31, an identifying module 32, an address recognizing module 33, and a downloading module 34. The communication module 31 is for receiving the obtained picture and the identification data transmitted from the portable device 20.

The identifying module 32 determines whether the user of the portable device 20 has authorization to use the downloading device 30. A predetermined identification data is stored in the downloading device 30. When the identification data transmitted from the portable device 20 is received, the identifying module 32 compares the received identification data with the predetermined identification data to determine whether the identification data is matched with the predetermined identification data. If the identification data does not match with the predetermined identification data, the identifying module 32 generates a notice and transmits the notice to the portable device 20 through the communication module 31. If the identification data matches with the predetermined identification data, the address recognizing module 33 recognizes the address data 10 in the received picture and changes the recognized address data 10 to a character string. During recognition of the address data 10, the address recognizing module 33 first recognizes the scheme name 101 such as“[url]” or “http:” in the address data 10, and then obtains the actual address 102 when the address end indication 103 is recognized. In the embodiment, the address recognizing module 33 recognizes the address data 10 according to the Optical Character Recognition (OCR) technology. The character string can be Unicode type or ASCII type.

The downloading module 34 is for downloading the required data from the server 50 according to the address data 10 through the communication module 31 and transmitting the required data to the portable device 20 through the communication module 31.

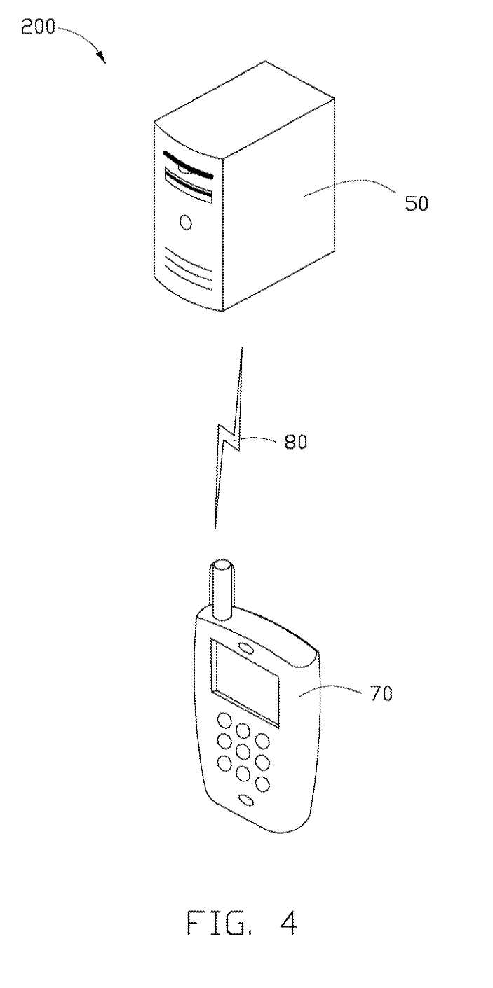

FIG. 4 is a hardware architecture diagram of the system 200 in accordance with a second embodiment. The system 200 includes a portable device 70 and the server 50. The portable device 70 is connected to the server 50 through a connection 80. The connection 80 is a wireless network connection such as GSM or CDMA.

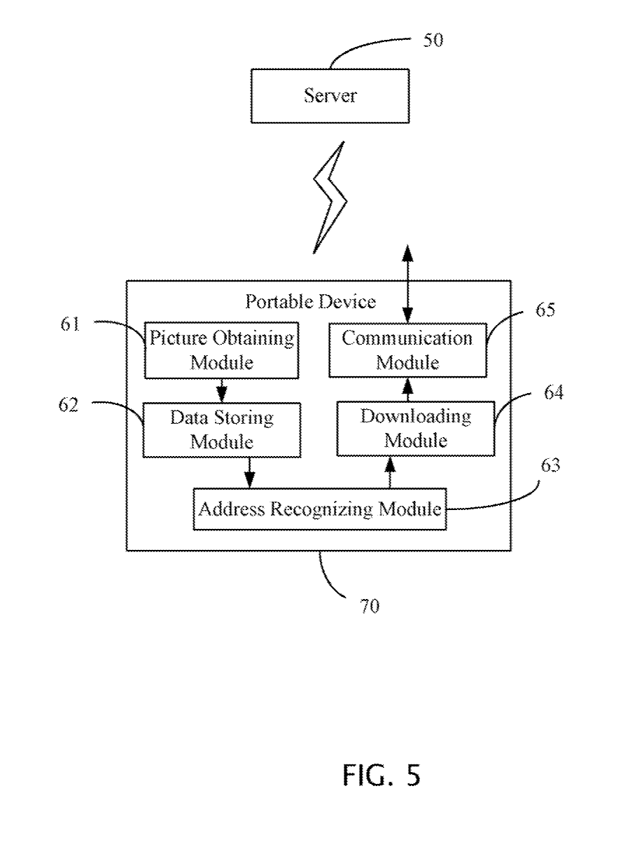

FIG. 5 is a block diagram of the portable device 70 of FIG. 4. The portable device 70 includes a picture obtaining module 61, a data storing module 62, an address recognizing module 63, a downloading module 64, and a communication module 65. The picture obtaining module 61 is for obtaining the picture which includes an address data 10 of the required data stored in the server 50. The data storing module 62 stores the obtained picture. The format of the address data 10 in this embodiment is the same as in the first embodiment. The address recognizing module 63 recognizes the address data 10 in the obtained picture and changes the recognized address data 10 to a character string. The downloading module 64 is for downloading the required data from the server 50 according to the address data 10 through the communication module 65.

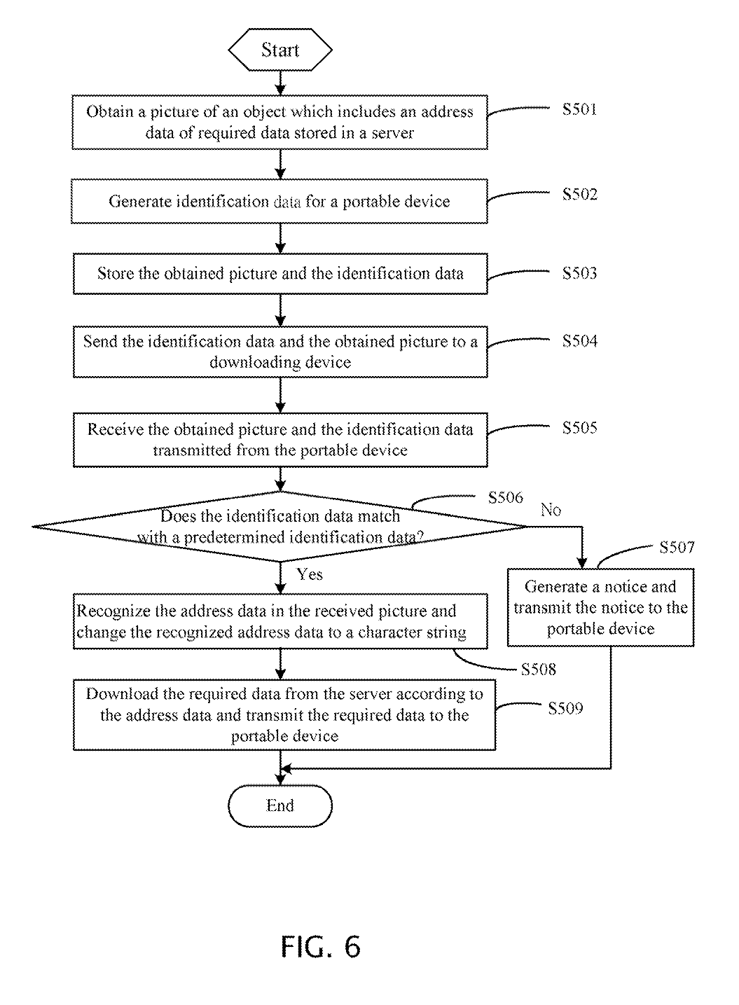

FIG. 6 is a flowchart of a data downloading method applied to the system of FIG. 1. In step S501, the picture obtaining module 21 obtains the picture of the object which includes address data 10 of the required data stored in the server 50.

In step S502, the identifying data generating module 24 generates identification (ID) data for the portable device 20.

In step S503, the data storing module 23 stores the obtained picture and the identification data.

In step S504, the communication module 22 sends the identification data and the obtained picture to the downloading device 30.

In step S505, the communication module 31 receives the obtained picture and the identification data transmitted from the portable device 20.

In step S506, the identifying module 32 compares the received identification data with the predetermined identification data to determine whether the identification data is matched with the predetermined identification data.

In step S507, if the identification data does not match with the predetermined identification data, the identifying module 32 generates a notice and transmits the notice to the portable device 20 through the communication module 31.

In step S508, if the identification data is matched with the predetermined identification data, the address recognizing module 33 recognizes the address data 10 in the received picture and changes the recognized address data 10 to a character string.

In step S509, the downloading module 34 downloads the required data from the server 50 according to the address data 10 through the communication module 31 and transmits the required data to the portable device 20 through the communication module 31.

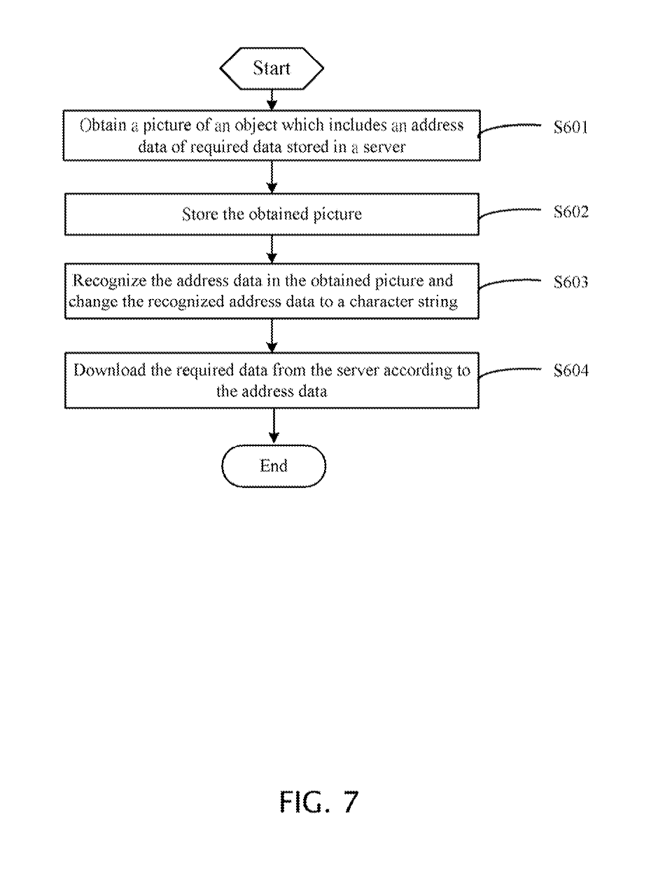

FIG. 7 is a flowchart of a data downloading method applied to the system of FIG. 4. In step S601, the picture obtaining module 61 obtains the picture of the object which includes the address data 10 of the required data stored in the server 50

In step S602, the data storing module 62 stores the obtained picture.

In step S603, the address recognizing module 63 recognizes the address data 10 in the obtained picture and changes the recognized address data 10 to a character string.

In step S604, the downloading module 64 downloads the required data from the server 50 according to the address data 10 through the communication module 65.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A downloading device connected to a server and a portable device, the portable device for obtaining a picture of an object that includes an address data of required data stored in the server, the downloading device comprising:
a communication module for receiving the obtained picture transmitted from the portable device;
an address recognizing module for recognizing the address data from the received picture and changing the recognized address data to a character string; and
a downloading module for downloading the required data from the server according to the address data through the communication module and transmitting the required data to the portable device through the communication module.

2. The downloading device as described in claim 1, further comprising an identifying module for determining whether the user of the portable device has a use authority of the downloading device, if the user of the portable device has a use authority of the downloading device, the address recognizing module is active.

3. The downloading device as described in claim 2, wherein the identifying module generates a notice and transmits the notice to the portable device through the communication module if the user of the portable device does not has the use authority of the downloading device.

4. The downloading device as described in claim 2, wherein a predetermined identification data is stored in the downloading device, the way of determining the use authority of the downloading device is: when identification data transmitted from the portable device is received, the identifying module compares the received identification data with the predetermined identification data to determine whether the identification data is matched with the predetermined identification data, if the identification data matches with the predetermined identification data, the user of the portable device has a use authority, if the identification data does not match with the predetermined identification data, the user of the portable device does not have the user authority.

5. The downloading device as described in claim 4, wherein the portable device is a cell-phone, the identification data is the International Mobile Equipment Identity (IMEI) of the cell-phone.

6. The downloading device as described in claim 4, wherein the identification data is biometric data of the user collected by the portable device.

7. The downloading device as described in claim 1, wherein the address data includes an address beginning indication, an actual address, and an address end indication, during recognizing the address data, the address recognizing module first recognizes the scheme name in the address data, and then obtains the actual address when the address end indication is recognized.

8. The downloading device as described in claim 7, wherein the address recognizing module recognizes the address data according to the Optical Character Recognition (OCR) technology.

9. A portable device, being connected to a server, comprising:
a picture obtaining module for obtaining a picture of an object which includes an address data of required data stored in the server;
a data storing module for storing the obtained picture;
an address recognizing module for recognizing the address data in the obtained picture and changing the recognized address data to a character string; and
a downloading module for downloading the required data from the server according to the address data through a communication module.

10. The portable device as described in claim 9, wherein the address data includes an address beginning indication, an actual address, and an address end indication, during recognizing the address data, the address recognizing module first recognizes the scheme name in the address data, and then obtains the actual address when the address end indication is recognized.

11. The portable device as described in claim 10, wherein the address recognizing module recognize the address data according to the Optical Character Recognition (OCR) technology.

12. The portable device as described in claim 9, wherein the portable device is connected to the server through GSM or CDMA connection.

13. A data downloading method, comprising:
obtaining a picture of an object which includes an address data of required data stored in a server;
storing the obtained picture;
recognizing the address data in the obtained picture and changes the recognized address data to a character string; and
downloading the required data from the server according to the address data.

14. The method as described in claim 13, further comprising determining whether user has a use authority to download the required data stored in the sever before recognizing the address data in the obtained picture, if the user has a use authority, the address data recognizing step is implemented.

15. The method as described in claim 14, further comprising generating a notice if the user of the portable device does not has the use authority.

16. The method as described in claim 14, wherein the way of determining the use authority comprising: comparing the received identification data with a predetermined identification data to determine whether the identification data matches with the predetermined identification data.

17. The method as described in claim 13, wherein the address data includes an address beginning indication, an actual address, and an address end indication, during recognizing the address data, recognizing the scheme name in the address data firstly, and then obtaining the actual address when the address end indication is recognized.
